(19) United States
(12) Patent Application Publication
(10) Pub. No.: US 2018/0354817 A1
(43) Pub. Date: Dec. 13, 2018

(54) PROCESSES AND SYSTEMS FOR ZINC WASTE REDUCTION

(71) Applicant: SIEMENS ENERGY, INC., Orlando, FL (US)

(72) Inventor: Philip A. BURCLAFF, Weston, WI (US)

(21) Appl. No.: 15/780,245

(22) PCT Filed: Dec. 2, 2016
(86) PCT No.: PCT/US2016/064666

§ 371 Date: May 31, 2018

Related U.S. Application Data
(60) Provisional application No. 62/262,794, filed on Dec. 3, 2015.

(51) Int. Cl. C02F 1/44; C02F 1/42; B01D 61/02

(52) U.S. Cl. CPC C02F 1/441; C02F 1/42; C02F 2101/20; C02F 2001/422; B01D 61/025

(57) ABSTRACT

Systems and processes are provided herein for selectively removing zinc from a zinc fluid in order to substantially reduce an amount of zinc waste for disposal in particular settings, such as in an offshore drilling environment.

### CROSS-REFERENCE TO RELATED APPLICATIONS

This application claims priority to and the benefit of the filing dates of U.S. Provisional Application No. 62/262,794, filed Dec. 3, 2015, and U.S. Provisional Application No. 62/316,004, filed Mar. 31, 2016, the entirety of each of which is hereby incorporated by reference.

### FIELD

This invention relates to fluid treatment processes and systems, and in particular to processes and systems for reducing zinc waste volume when zinc waste volume is of concern.

### BACKGROUND

After drilling an oil well, a dense brine, also known as a completion fluid, may be pumped down the well to control the well pressure while the well is being completed and prepared for production. Fluids comprising calcium chloride (CaCl₂) and/or calcium bromide (CaBr₂) are commonly used brines for this purpose. However, in the case of deep wells, such as subsea wells off the shelf in the Gulf of Mexico, zinc bromide (ZnBr₂) may also be mixed in the brine for denser fluids with lower crystallization temperatures.

Once production starts on the well, the completion fluid and other chemicals come back up out of the well as what is called flowback fluid or water. Typically, after a couple months, the flowback water has fully returned from the well, and produced water from the formation returns with the oil. In cases where zinc is used, the flowback water will almost certainly be contaminated with zinc. Since zinc is a marine pollutant, such flowback water requires additional treatment to remove the zinc before it can be discharged into the ocean, for example. In addition, produced water may still contain zinc levels that are lower than the flowback water, but still may also require treatment prior to disposal.

In the context of offshore drilling, platform operators have generally deemed it better to collect the aforementioned zinc fluids and transport them to shore rather than treating them on the platform—even upon consideration of the large expense of collecting and shipping the fluids. Since both shipping to onshore locations and disposal of waste (onshore) are generally considered on a per volume basis, it would be desirable to reduce the volume of zinc waste to be transported onshore for shipment or disposal when feasible.

### SUMMARY

In accordance with an aspect, there are provided processes and systems for removing zinc from a zinc fluid (hereinafter “zinc fluid”) such as a flowback fluid or produced water. Advantageously, the processes and systems described herein produce a zinc-free or zinc-reduced fluid that may be readily discharged to the ocean or other location. In one aspect, the processes and systems may also significantly reduce the amount of zinc-containing waste for transport, storage, or disposal. In the context of offshore drilling, the systems and processes described herein may significantly reduce the volume of zinc waste that needs to be shipped onshore for disposal or further treatment (since again both shipping and disposal are expensive on a per volume basis). In some embodiments, the small footprint for the solutions described herein also allow for treatment of a zinc fluid offshore, eliminate the need for transport of a zinc fluid onshore, and allow for discharge of a treated fluid to the ocean or other body of water when the zinc concentration has been reduced below acceptable limits.

In accordance with an aspect, the processes and systems may utilize a concentrator, such as a reverse osmosis unit, and repeatedly cycle a zinc fluid through the concentrator, thereby generating a first dischargeable fluid volume from the zinc fluid whilst concentrating the zinc and generating a zinc concentrate suitable for transport, storage, further treatment, or the like. The zinc concentrate may have a significantly reduced volume compared to the original zinc fluid volume.

In accordance with another aspect, a concentration process, such as reverse osmosis, may first be utilized to concentrate zinc from a zinc fluid in one or more cycles and generate a concentrated stream comprising the zinc. It is appreciated herein that the concentrated stream comprises at least zinc, but may further comprise other compounds, ionic species, and salts, such as calcium bromide.

In an embodiment, the concentration process may also be effective to generate a dischargeable first fluid volume having a reduced amount of zinc (relative to the zinc fluid). In an embodiment, the zinc present in the concentrate is in the form of a complex ion (ZnCl₄²⁻) when the total dissolved solids (TDS) concentration is greater than 70 g/L, which renders the zinc selectively removable from the concentrate by an anionic ion exchange resin. Thus, in an embodiment, the resulting zinc concentrate may be subsequently subjected to ion exchange with an anionic ion exchange material to selectively remove zinc from the zinc concentrate and generate a second dischargeable fluid volume having a reduced amount of zinc (relative to the zinc concentrate).

In an embodiment, the anionic ion exchange resin may not retain other cationic salts. In this way, such cationic salts may pass into in the second dischargeable fluid volume, which may be of interest. In this way, the effluent from ion exchange can be reused if desired. In an embodiment, the first and/or second dischargeable fluid volumes may be reused, for example, as a completion fluid. In yet another embodiment, the first and/or second fluid dischargeable fluid volumes may be discharged to the ocean (or other appropriate location) if the zinc concentration is below a predetermined value or discharge limit. In further embodiments, a permeate from reverse osmosis may also be utilized for regeneration of the ion exchange material.

In accordance with another aspect, a zinc fluid may be first contacted with an anionic ion exchange resin to remove zinc from the zinc fluid and to generate a first dischargeable fluid volume (having a reduced zinc concentration relative to the zinc fluid). In an embodiment, zinc in the zinc fluid is in the form of a complex ion (e.g., ZnCl₄²⁻) when the total dissolved solids (TDS) concentration is greater than 70 g/L, which renders the zinc selectively removable from the concentrate by the anionic exchange resin. Thereafter, the process may include generating a regeneration fluid from a concentration process, such as reverse osmosis. The regeneration fluid is one having a TDS concentration below about 1000 mg/L, and in some embodiments less than 500 mg/L. In an embodiment, the generating of the regeneration fluid is done by subjecting at least a portion of the first dischargeable fluid volume to a concentration process, e.g., reverse osmosis, to further reduce an amount of TDS therein. In another embodiment, the generating of the regeneration fluid is done by subjecting seawater to reverse osmosis. In an embodiment, the anionic ion exchange material may be regenerated using at least a portion of the regeneration fluid (permeate) from reverse osmosis. The resulting zinc-loaded effluent from regeneration may also be subjected to the concentration process in order to reduce the volume of the zinc-loaded waste or may be transported, e.g., onshore, for disposal.

In accordance with another aspect, there is provided a process for reducing zinc waste volume. The process comprises concentrating a zinc fluid comprising zinc and a total dissolved solids concentration of less than 70 g/L to generate a concentrate having zinc and a TDS concentration of at least about 70 g/L; and contacting the concentrate with an anionic ion exchange resin to retain the zinc on the resin and to generate a zinc-reduced effluent.

In accordance with another aspect, there is provided a system for reducing zinc waste volume. The system comprises a source of a zinc fluid comprising zinc and a total dissolved solids (TDS) concentration of less than 70 g/L; a concentrator in fluid communication with the source of zinc fluid, the concentrator configured to generate a concentrate having zinc and a TDS concentration of at least about 70 g/L; and an anionic ion exchange resin in communication with an outlet of the concentrator and configured to receive the concentrate and retain zinc from the concentrate thereon.

In accordance with another aspect, there is provided yet another process for reducing zinc waste volume. The process comprises contacting a zinc fluid with an anionic ion exchange resin to generate a zinc-reduced effluent, the zinc fluid comprising zinc and a total dissolved solids concentration of about 70 g/L or more; generating a regeneration fluid having a total dissolved solids concentration of less than 10 g/L; and regenerating the anionic ion exchange resin with the regeneration fluid.

In accordance with another aspect, there is provided a system for reducing zinc waste volume. The system comprises a source of a zinc fluid comprising zinc and a total dissolved solids (TDS) concentration of about 70 g/L or more; an anionic ion exchange resin in fluid communication with the source of the zinc fluid, the anionic ion exchange resin configured to generate a zinc-reduced effluent stream; a concentrator in fluid communication with the anionic ion exchange resin configured to generate a regeneration fluid having a total dissolved solids concentration of less than 10 g/L.

In accordance with another aspect, there is provided a process for reducing zinc waste volume. The process comprises directing zinc fluid from a storage vessel to a concentrator to generate a concentrate and a zinc-reduced fluid; returning the concentrate to the storage vessel; and repeating the directing and returning one or more times to produce a reduced volume and concentrated zinc product in the storage vessel.

In accordance with another aspect, there is provided a system for reducing zinc waste comprising a storage vessel comprising an amount of a zinc fluid; a concentrator having an inlet in fluid communication with an outlet of the storage vessel, the concentrator configured to produce a concentrate and a zinc-reduced fluid; and a recirculation line extending between an outlet of the concentrator and an inlet of the storage vessel for allowing flow of the concentrate from the concentrator to the storage vessel.

### BRIEF DESCRIPTION OF THE DRAWINGS

The invention is explained in the following description in view of the drawings that show:

FIG. 1 is a schematic illustration of a system in accordance with an aspect of the invention.

FIG. 2 is a schematic illustration of a system in accordance with another aspect of the invention.

FIG. 3 is a schematic illustration of a system in accordance with another aspect of the invention.

FIG. 4 is a schematic illustration of additional components for a system in accordance with an aspect of the present invention.

FIG. 5 is a schematic illustration of an ion exchange column arrangement in accordance with an aspect of the present invention.

FIG. 6 is a schematic illustration of an ion exchange column arrangement in accordance with an aspect of the present invention.

### DETAILED DESCRIPTION

To facilitate an understanding of embodiments, principles, and features of the present invention, they are explained hereinafter with reference to implementation in illustrative embodiments. Embodiments of the present invention, however, are not limited to use in the described systems. The components and materials described hereinafter as making up the various embodiments are intended to be illustrative and not restrictive. Many suitable components and materials that would perform the same or a similar function as the materials described herein are intended to be embraced within the scope of embodiments of the present invention.

As used herein, the term “about” means ±5% of a stated value.

As used herein, the term “effective amount” or the like means an amount suitable to bring about an intended result.

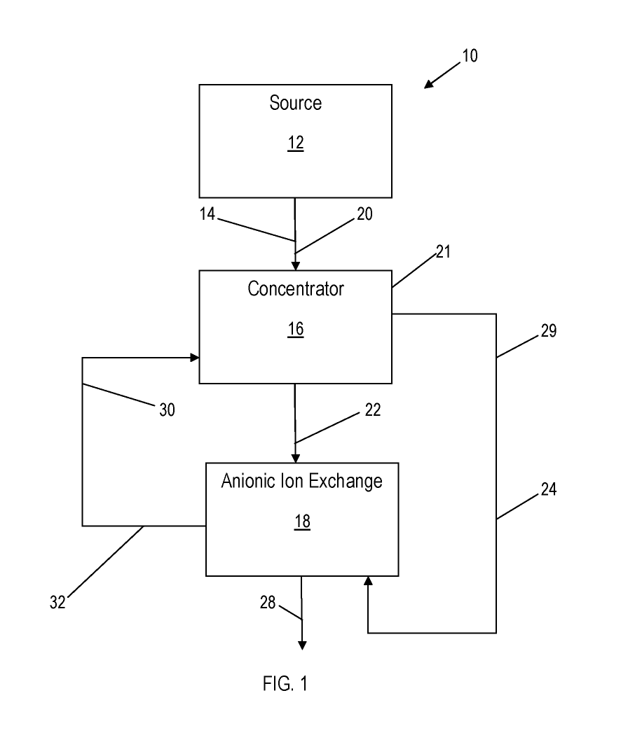

Now referring to the figures, FIG. 1 illustrates a first embodiment of a system 10 for reducing zinc waste volume. The system 10 includes a source 12 of a zinc fluid 14, a TDS concentrator (concentrator) 16 in fluid communication with the source 12, and an anionic ion exchange resin 18 in fluid communication with the TDS concentrator 16. The source 12 may comprise any source of a zinc fluid 14 as described herein. In an embodiment, the source 12 comprises a suitable housing or vessel for storing a desired amount of the zinc fluid 14. In an embodiment, the source 12 may comprise a process flow such as a flow of produced water or flowback water. The source 12 may include any suitable number of inlets and outlets for intake and release of the subject materials therein, and may include any suitable number of pumps, valves, and the like to control the same. The number and location of the inlets and outlets is without limitation, and may be any number/location suitable for the particular system.

The zinc fluid 14 may comprise any aqueous fluid having an amount of zinc therein. In an embodiment, the zinc fluid 14 may have a concentration of from about 1 mg/L to about 5000 mg/L, and in a particular embodiment from 1 to 3000 mg/L. In addition, the zinc fluid 14 may be a component of a total dissolved solids (TDS) content of the fluid. In an embodiment, the amount of zinc in the zinc fluid 14 is less than 10 percent by weight of the TDS concentration. In one aspect, the process components and steps described herein may be based at least, in part, on a measurement of the TDS content of the zinc fluid 14 at various points in the process as will be explained in further detail below. In certain embodiments also, the zinc fluid 14 may be treated by another process before delivery to the zinc source 12 and/or the TDS concentrator 16, such as a process for removing oil and organic and/or inorganic contaminants from the zinc fluid 14.

In one aspect, the zinc fluid 14 may comprise produced water or a flowback fluid as is known in the art, and thus may be a fluid produced as a byproduct in the recovery of oil or gas. In other embodiments, the zinc fluid 14 may comprise a completion fluid as is known in the art. Completion fluids typically have a density greater than water and are generally utilized in a well to facilitate final operations prior to initiation of well production. Completion fluids are typically brines, such as those comprising zinc and calcium. In an embodiment, the zinc fluid 14 may comprise a flowback fluid (e.g., flow-back water) that includes a completion fluid that has been collected or otherwise has or is returning toward a ground surface after being injected into a well.

In the embodiment of FIG. 1, the zinc fluid 14 comprises zinc and a total dissolved solids (TDS) concentration of less than 70 g/L. In an embodiment, the zinc fluid 14 also includes sodium and/or calcium salts, such as calcium chloride, with smaller amounts of zinc bromide as a contaminant. While not wishing to be bound by theory, it is believed that a TDS concentration of at least 70 g/L will promote the complexing of zinc with present chlorides to form a complex ion such as ZnCl₄²⁻ (tetrachlorozincate anion). In an embodiment, these complex zinc ions can then be selectively removed from the zinc fluid 14 utilizing the anionic ion exchange resin 18 as discussed below, thereby leaving the other cationic salts, e.g. sodium/calcium, in the effluent therefrom (which may be desirable in some applications). The resulting zinc-scrubbed fluid can then be readily discharged to the ocean or reused as a completion fluid in certain embodiments. For example, when the zinc fluid 14 includes calcium halide salts, the complex zinc ions may be removed by the anionic ion exchange resin while the calcium salts pass therethrough, thereby leaving a zinc-scrubbed fluid containing the calcium salts. This zinc-scrubbed fluid may be reused as a completion fluid, for example.

The TDS concentrator (concentrator) 16 may be any suitable device which receives the zinc fluid 14 and generates a concentrate 22 having a concentration of TDS, including zinc, greater than the zinc fluid 14. In an embodiment, zinc (as well as other species) may be present in the zinc fluid 14, and the concentrator 16 increases the zinc and TDS concentration (relative to the zinc fluid 14) to generate a concentrate 22 with an overall TDS content suitable to subject the concentrate 22 to ion exchange treatment as described herein. In addition, the concentrator 16 generates a zinc and TDS-reduced effluent (also called “a first dischargeable fluid volume) suitable for immediate discharge in some instances. In an embodiment, the resulting concentrate 22 also has a reduced volume relative to the incoming zinc fluid 14. In certain embodiments, the TDS concentrator 16 may comprise a reverse osmosis (RO) unit 21 as shown in FIG. 1 and as is known in the art.

The RO unit 21 may comprise any suitable apparatus known in the art that utilizes a reverse osmosis process in order to produce a concentrated stream (with increased TDS) and a permeate stream (with decreased TDS) from the zinc fluid 14. Generally, reverse osmosis takes place when pressure applied to a concentrated solute solution causes the solvent to pass through one or more membranes of the RO unit 21 to form a lower concentrated solution, thus leaving a higher concentration of solute on one side, and solvent having less solute on the other. In this instance, the RO unit 21 thus produces a concentrate 22 on one side and a permeate (first dischargeable fluid volume) 24 on the other side. Numerous RO units are readily commercially available. By way of example, the membrane(s) of the RO unit 21 may be composed of cellulose acetate and/or an aromatic polyamide. In another embodiment, the TDS concentrator 16 may comprise one or more nanofiltration membranes having a pore size suitable for also forming a concentrate on the one hand and a TDS and zinc-reduced permeate on the other, which may be utilized in the same manner. In still other embodiments, the TDS concentrator 16 may comprise any other apparatus configured to generate a TDS or zinc-reduced fluid and a concentrated zinc and TDS fluid. For example, the TDS concentrator 16 may further include an evaporator, a forward osmosis unit, any other membrane-based technology, or any other brine concentrator as are known in the art.

The anionic ion exchange resin 18 may comprise any material suitable for retaining an amount of zinc thereon when contacted with a zinc-containing fluid, such as the zinc concentrate. In an embodiment, the anionic exchange resin 18 comprises a material that will selectively remove zinc or a zinc-containing material, ionic complex, or compound from the zinc concentrate. In this way, the anionic ion exchange resin 18 comprises a material which selectively removes zinc (relative to other ions present in the zinc fluid 14) from the zinc fluid 14. When the zinc fluid 14 comprises produced or flowback water, for example, the anionic ion exchange resin 18 may selectively remove zinc relative to other metal cations and halides in the water. In an embodiment, the anionic ion exchange resin 18 may selectively remove zinc in a complex zinc ion form, e.g., ZnCl₄²⁻ from other components in the fluid delivered to the resin 18. In addition, in an embodiment, the anionic ion exchange resin 18 comprises a strong basic anionic (SBA) exchange resin as is known in the art. In other embodiments, the anionic ion exchange resin 18 may comprise a weak base anionic ion exchange resin. The anionic ion exchange resin 18 may be disposed within any suitable vessel or housing, such as a columnar-shaped housing having at least one inlet or outlet or the like.

In operation, the zinc fluid 14 is directed from the zinc source 12 to the concentrator 16 at a suitable flow rate via line 20. As mentioned, in an embodiment, one aim of the concentrator 16 is to increase the TDS concentration such that a fluid (concentrate) is produced having a TDS concentration (including zinc) of at least about 70 g/L. In this way, the TDS concentration will be such that the presence of complex zinc ions is at least promoted, which can selectively be removed by ion exchange. In an embodiment, the zinc is at least present in the form of ZnCl₄²⁻ (tetrachlorozincate anion) when the TDS concentration is increased to at least about 70 g/L. In the embodiment shown, the concentrator 16 comprises a reverse osmosis (RO) unit 21 which produces a concentrate 22 and a permeate (first dischargeable fluid volume) 24.

From the RO unit 21, the concentrate 22 may be directed to the anionic ion exchange resin 18 at a suitable flow rate via line 26. As the concentrate 22 flows through the anionic exchange resin 18, TDS, including zinc, will be removed from the concentrate 22 and an effluent (second dischargeable fluid volume) 28 will be produced. In an embodiment, the first dischargeable fluid volume (permeate) 24 and the second dischargeable fluid volume (effluent) 28 may be combined and delivered for discharge to the ocean, storage, transport, disposal, reuse, or the like. In another embodiment, the second dischargeable fluid volume 28 is directed to storage, transport, disposal, reuse, or the like and the first dischargeable fluid volume 24 is utilized to regenerate the anionic ion exchange resin 18 (as shown) by directing the first dischargeable fluid volume (permeate) 24 through line 29 and through the resin 18 under suitable temperature, pH, and/or flow rate conditions. In certain embodiments, the regeneration is done by passing the first dischargeable fluid volume 24 in a direction of flow opposite the direction that the concentrate 22 passes through the resin 18. The resulting regeneration effluent stream 30 carrying zinc may be directed via recirculation line 32 back to the source 12 or the concentrator 16 (as shown in FIG. 1) to reconcentrate the zinc therein and provide further regeneration fluid without adding additional fluid requirements to the system 10.

In certain embodiments, it may be desirable to increase the TDS concentration to well over 70 g/L such that the TDS of the zinc concentrate remains greater than 70 g/L as the zinc concentrate travels through the anionic ion exchange resin 18. In this way, zinc is primarily in the complex ionic form discussed and/or otherwise selectively removable from other components delivered to the resin 18. However, it is noted that the TDS concentrate in the concentrate 22 may reach a point where it is too concentrated for the membranes of the RO unit 21 (e.g., the osmotic pressure is too high for the membranes' rating such that they cannot safely operate). Thus, the concentrate 22 may have a maximum TDS concentration in certain embodiments. In a particular embodiment, from the concentrator 16, the concentrate 22 may have a TDS concentration of greater than 70 g/L but less than 100 g/L, and in particular embodiments less than 90 g/L.

The above embodiment described a system useful where the TDS concentration is intentionally increased via a concentration process, e.g., reverse osmosis, so as to promote complex zinc ion formation, which may be removed via ion exchange. The two stage approach may significantly reduce zinc waste volume—in some instances to 1/400^{th} of the original volume. However, in other embodiments, a concentration process, e.g., reverse osmosis, alone (without ion exchange) may be utilized in order to reduce zinc waste to an appreciable degree. In an embodiment, a concentration process alone, e.g., reverse osmosis, may be suitable for reducing zinc waste when the zinc concentration is a relatively high percentage of the TDS concentration of the zinc fluid 14. In a particular embodiment, a concentration process such as reverse osmosis may be utilized without ion exchange when the zinc concentration is greater than 10% by weight of the total TDS concentration. This is due to the fact that as the percentage of zinc as a portion of the TDS content increases, the zinc waste volume reduction benefits via adding ion exchange decrease. At some point, it is appreciated that the volume reduction by adding ion exchange may not support the capital costs of adding the ion exchange components.

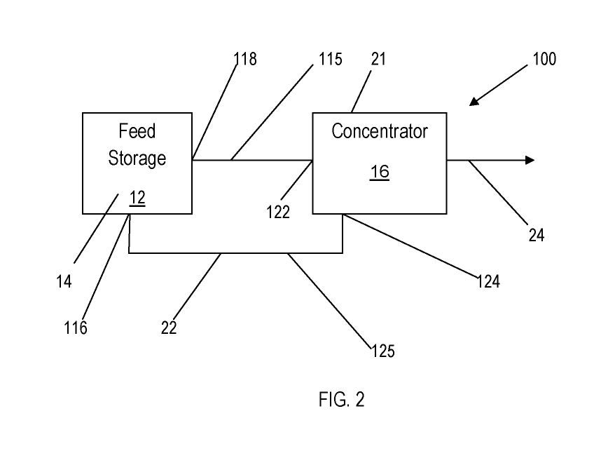

Accordingly, in one aspect of the present invention, a process without ion exchange is also disclosed, wherein the zinc fluid 14 may be repeatedly cycled through a concentrator 16, e.g., an RO unit 21, to generate a zinc concentrate having a reduced volume and a zinc-reduced fluid which may be discharged to the ocean or directed to disposal, storage, transport, reuse, or the like. By way of example and referring to FIG. 2, there is shown another embodiment of a zinc removal system 100 in accordance with an aspect of the present invention. In this embodiment, the system 100 includes a storage vessel (feed storage) 12 comprising an amount of the zinc fluid 14 therein and a concentrator 16, e.g., a reverse osmosis (RO) unit 21. The storage vessel 112 includes at least one inlet 116 and at least one outlet 118, and may comprise any open or closed vessel having a volume sufficient to hold the desired amount of fluid to be processed.

The concentrator 16, e.g., RO unit 21 in the embodiment shown, similarly includes at least one inlet 122 and at least one outlet 124. The outlet 118 of the storage vessel 112 is in fluid communication (such as via line 115) with the inlet 122 of the RO unit 21 such that zinc fluid 14 may be delivered from the storage vessel 112 to the RO unit 21. Upon delivery of the zinc fluid 14 thereto, the RO unit 21 is configured to produce a TDS and zinc concentrate 22 (concentrate 22) and a TDS and zinc-reduced permeate 24 (permeate 24) as already described herein. An outlet 124 of the RO unit 120 may be in fluid communication with the inlet 116 of the storage vessel 112, such as via recirculation line 125, such that the concentrate 22 may be repeatedly delivered from the RO unit 21 to the storage vessel 112 as described below.

To further explain the operation of the embodiment of FIG. 2, a suitable amount of the zinc fluid 14 may be directed to the storage vessel 112. In an embodiment, the zinc fluid 14 comprises a starting TDS concentration of about 10 g/L or less in the vessel 112, although it is understood that the present invention is not so limited. With current reverse osmosis units, it is appreciated that too high a TDS content fed through the membranes of the RO unit 20 may result in destruction of the membranes or otherwise sub-optimal operation. For example, in an embodiment, it may be desirable to maintain the TDS concentration below about 100 g/L. In another embodiment, the RO unit 21 may have a maximum allowable pressure, e.g., 1000 psi, such that the zinc fluid 14 may be cycled through the RO unit 20 a plurality of times (e.g., two or more) without damaging the membranes of the RO unit 20 whilst producing a zinc concentrate 22 and a zinc-reduced permeate 24 in each cycle.

In certain embodiments, the zinc fluid 14 may be flowed through an oil separation unit for filtering out hydrocarbons from the zinc fluid 14 (if present) and/or another pre-treatment unit prior to delivery to the storage vessel 112 or the RO unit 21. In an embodiment, the zinc fluid 14 may be treated for oil or organic/inorganic contaminants within each cycle of the process. In other embodiments, the zinc fluid 14 may be delivered directly from the vessel 112 to the RO unit 21 without any additional treatment. In any case, in each cycle, the concentrate 22 may be returned from the RO unit 21 to the storage vessel 112 via the recirculation line 125. In addition, a zinc reduced permeate 24 is generated by the RO unit 21 having a reduced amount of zinc relative to the zinc fluid 14.

The process of delivering fluid from the vessel 112 after delivery of concentrate 22 to the vessel 112 can be repeated multiple times. It can readily be appreciated that with each pass through the RO unit 21, the volume in the storage vessel 112 will decrease (assuming no further addition of zinc fluid 14) while more permeate (first dischargeable fluid volume) 24 is generated. In certain embodiments, such as when the process is employed on an offshore platform, the permeate 24 may be readily discharged into the ocean—assuming the permeate 24 now includes a zinc concentration below allowable limits for discharge. If for some reason the zinc concentration is too high for discharge, the permeate 24 may also be returned to the storage vessel 112 for additional processing. In other embodiments, the permeate 24 may be delivered to storage for transport, discharge (if zinc is below acceptable limits), or the like. In an embodiment, the permeate 24 comprises a zinc concentration of about 1 mg/L or less.

In another aspect, the zinc fluid 14 may be delivered to the RO unit 21 at a suitable feed rate, volume, and pressure such that the membranes of the RO unit 21 are not damaged by the incoming flow. One consideration is that as the TDS delivered to the RO unit 21 increases, the fraction generated as permeate 24 decreases. At some point, the RO unit 121 may be operating at or near its maximum rated pressure. In this case, the TDS concentration in the zinc fluid 14 may be so high that no fluid will travel through the membrane(s) of the RO unit 21. In an embodiment, the zinc fluid 14 may be delivered to the RO unit 21 until the TDS is at ˜80 g/L. At that concentration or higher, the osmotic pressure in the RO unit 21 may start to be too high for any significant zinc fluid 14 to travel through the membrane(s) of the RO unit 21. At such time, the contents of the vessel 112 may be emptied, and further fresh zinc fluid 14 may be delivered to the vessel 112 for treatment.

In certain embodiments, the processes described herein may be repeated until the zinc fluid 14 in the storage vessel 112 comprises a TDS and/or zinc concentration greater than a predetermined amount, or is otherwise deemed complete. In an embodiment, the predetermined amount may be a TDS concentration of at least about 60 g/L, and in a particular embodiment, from about 70 g/L to about 100 g/L. The measuring of the TDS and/or zinc concentration in the storage vessel 112 may be done via any suitable device or technique, such as via conductivity meter. Once determined that no further zinc fluid 14 is desired to be or should be delivered to the RO unit 21, the storage vessel 112 may be emptied of the concentrated zinc fluid 14 and the storage vessel 112 may again be filled with an initial quantity of the zinc fluid 14.

In accordance with another aspect, there is provided another system and process for reducing zinc waste volume, wherein reverse osmosis may be utilized to support an ion exchange process. In this embodiment, however, reverse osmosis is not utilized to concentrate the zinc fluid 14 prior to delivery to ion exchange. For example, a portion of a zinc-reduced effluent from the anionic ion exchange resin 18 may be directed through an RO unit, thereby creating low TDS water required to regenerate the anionic exchange resin. Alternatively, seawater or another source of low TDS water can be directed to the RO unit 21 to generate the low TDS water for regeneration. The regeneration fluid byproduct (which comprises the complex zinc ion) may be directed through the RO unit once again to concentrate the zinc, thereby reducing the overall waste from the system. Testing on regenerating the anionic exchange resin showed diminishing returns in the regeneration. For example, in one experiment, six bed volumes of water stripped 70% of the zinc from the column, while another 4 bed volumes stripped only 15% more (85% total stripped). Without the RO unit included, the resin thus would not have been able to be regenerated completely without significant volumes of zinc-contaminated byproduct, leading to substantial amounts of zinc waste. With the use of a concentration process such as reverse osmosis or the like, however, additional regeneration fluid can be put through the anionic ion exchange resin, thereby regenerating the resin, while adding only slightly, if at all, to the overall waste volume that needs to be transported ashore.

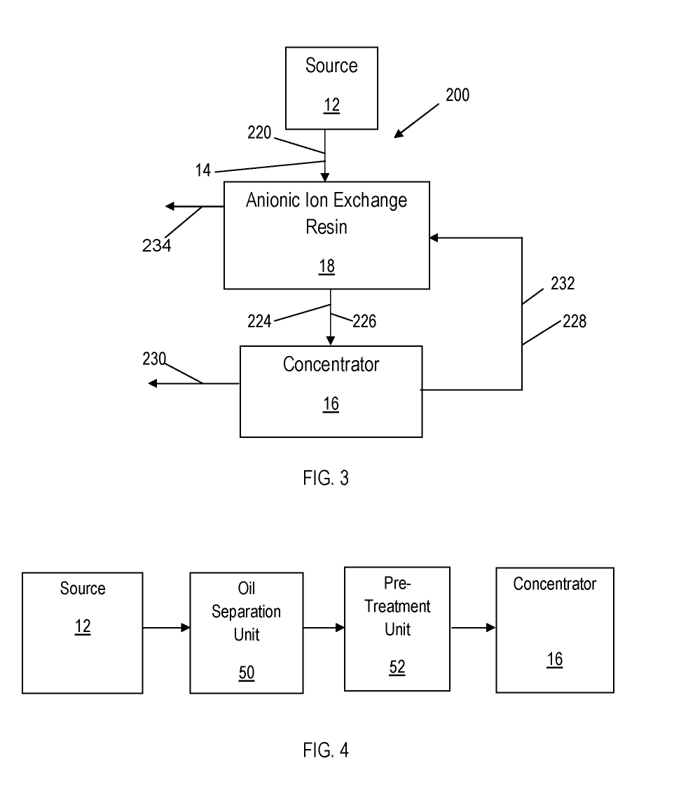

Referring to FIG. 3, there is shown an embodiment of such a system 200 for reducing zinc waste volume. As shown in FIG. 3, the system 200 comprises a source 12 of the zinc fluid 14, an anionic ion exchange resin 18 in fluid communication with the source 12 of the zinc fluid 14, a concentrator 16, e.g., a reverse osmosis unit 21, in fluid communication with the anionic ion exchange resin 18; and a fluid path 225 between an output of the reverse osmosis unit 21 and an inlet to the anionic ion exchange resin for flow of a reduced TDS stream (permeate 24) from the RO unit 21 to the anionic exchange resin 18. In an embodiment, the zinc fluid 214 may already have a TDS concentration of about 70 g/L or more at the source 12 or upon delivery to the anionic ion exchange resin 18. In this way, zinc may already be primarily in a complex anion form (ZnCl₄²⁻) as explained, and can readily be directed to an anionic exchange resin as described herein. Conversely, other aspects of the present invention utilized an RO unit 21 prior to delivery to the anionic ion exchange resin 18 to concentrate the zinc fluid 14 until the zinc fluid included a TDS concentration of 70 g/L or more.

In operation and referring again to FIG. 3, an amount of the zinc fluid 14 may be directed from the source 12 to the anionic exchange resin 16 via line 220. As discussed, the anionic exchange resin 18 may selectively remove zinc in complex ionic form from the zinc fluid 14 (relative to other present ionic species), thereby generating a zinc reduced effluent 224, which, in some embodiments, may also include non-zinc cationic salts such as calcium chloride or the like. The zinc-reduced effluent 224 may in turn be delivered to the concentrator 16, e.g., RO unit 21, via line 226 to further reduce an amount of total dissolved solids (TDS) in the zinc-reduced effluent 224. The concentrator 16 generates a permeate (regeneration fluid) 228 having a further reduced TDS concentration relative to the effluent 224 and a retentate 230, which may be recycled back to source 12 or otherwise directed to shipment onshore, storage, transport, or the like. To regenerate the anionic ion exchange resin, the regeneration fluid (permeate) 228 from the concentrator 16 may be directed through a fluid path 232 between an output of the RO unit 21 and an inlet to the anionic ion exchange resin 18 for flow of the regeneration fluid 228 to the anionic ion exchange resin 18. In an embodiment, the concentrator 16 may be effective to reduce an amount of TDS in the zinc reduced permeate 224 to less than 1000 mg/L TDS. During regeneration, the regeneration fluid 228 is flowed from the concentrator 16 through the anionic exchange resin 18, thereby generating a zinc-loaded fluid 234 at an outlet of the anionic exchange resin 18. The concentrated zinc-loaded fluid 234 may then be directed to storage and/or for transport onshore.

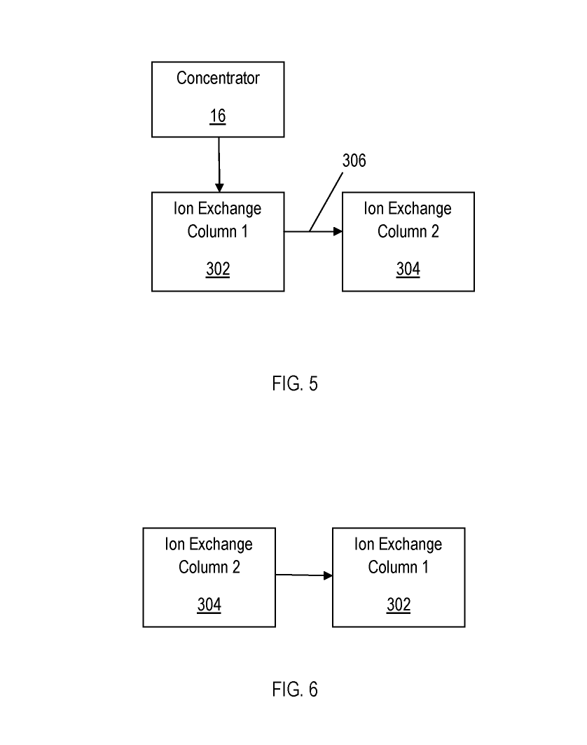

In accordance with another aspect of the present invention, the use of the anionic ion exchange resin may be optimized to minimize regeneration frequency and regeneration fluid volume, thereby also reducing fluid waste. Referring to FIG. 5, there is shown a system 300 comprising first ion exchange column 302 comprising the anionic ion exchange resin 18 and a second ion exchange column 304 comprising the anionic ion exchange resin 18 in flow series. In this configuration, the first ion exchange column 302 will operate primarily as a bulk removal device while the second ion exchange column 304 will operate primarily as a polishing device. In an embodiment, the zinc fluid 14 (if already sufficient TDS) or the concentrator 16 (if the starting zinc fluid 14 had low TDS) delivers a first amount of the zinc material (fluid 14 or concentrate 22) to the first ion exchange column 302. Zinc material is delivered to the first column 302 until there is breakthrough of zinc in the effluent 306 thereform. When an amount of zinc breaks through the first column 302, there may be a large portion of the resin 18 that is still only partially loaded. Thus, if the resin 18 in the first column 302 were regenerated, it would at least be premature, and certainly not optimal.

However, with a second column 304 in flow series with the first column 302 as shown in FIG. 5, the second column 304 may continue polishing while the first column 302 uses the rest of its “available” resin 18 for bulk zinc removal. Thereafter, after a predetermined duration or when the effluent from the first column includes an amount of zinc greater than a predetermined threshold, the first column 302 may be removed, regenerated under conditions described herein, and then put in flow series after the second column 304 as shown in FIG. 6. In this way, the regenerated first column 302 may replace the second column 304 as the polishing column while the partially loaded second column 304 may now serve as the new bulk removal column. In accordance with an aspect of the invention, allowing each column to become more fully loaded before regeneration (relative to single column use) reduces regeneration frequency and regeneration fluid use—in some cases as low as a third of what would be expected with single column systems. In this way, the above-described arrangement further limits fluid waste.

In accordance with an aspect, any of the systems and processes described herein may further include any additional components for treating the zinc fluid 14 prior to delivery of the zinc fluid 14 to its subsequent stage or apparatus, e.g., ion exchange or a concentrator. For example, in an embodiment, the zinc fluid 14 may comprise an amount of oil, suspended solids, and/or organic contaminants therein, each of which may undesirably foul RO membranes by way of example. Accordingly, it may be desirable to pre-treat the zinc fluid 14 before introduction of the same to the concentrator 16, the anionic ion exchange resin 18, or the like.

By way of example only and as shown in FIG. 4, the system 10 may include an oil separation unit 50 in fluid communication with a source of the zinc fluid 14 for filtering out an amount of hydrocarbons from the zinc fluid 14 prior to input to the concentrator 16. The oil separation unit 50 may comprise any suitable apparatus for removing an amount of oil from the zinc fluid 14. In a particular embodiment, for example, the oil separation unit 50 may comprise one or more vessels, any of which may be open or closed to the atmosphere and packed with a polymeric material, such as polyester fibers, to retain oil and/or suspended solids thereon or in void spaces therebetween. In other embodiments, the oil separation unit 50 may comprise one or more of an American Petroleum Institute (API) separator, a corrugated plate interceptor (CPI) separator, a filtration membrane, a vessel packed with filtration media (e.g., composite polymer/cellulose-based media) with or without a membrane module, a hydrocyclone, and a gravity clarifier to separate oil and suspended solids from the zinc fluid 14.

In another embodiment, the zinc fluid 14 may also be treated so as to remove a desired amount of inorganic or organic contaminants from the zinc fluid 14 prior to input to the concentrator 16. Any suitable apparatus, materials, or processes may be utilized in order to effect the removal of the organic contaminants. For example, as shown in FIG. 4, the system 10 may further include a pre-treatment unit 52 upstream of the concentrator 16 and downstream of the oil separation unit 50. In an embodiment, the pre-treatment unit 52 comprises a vessel packed with an amount of activated carbon. In a particular embodiment, the activated carbon comprises granulated activated carbon (GAC). In accordance with another aspect, the activated carbon comprises powdered activated carbon (PAC). One example of a known powder activated carbon material and system is offered by Siemens Water Technologies under the trademark “PACT®.” Using activated carbon, organic and inorganic compounds in the zinc fluid 14 may be physically adsorbed to the surface of the activated carbon particles, thereby removing contaminants from the zinc fluid 14 prior to introduction of the zinc fluid 14 to the concentrator 16. Once spent, it is appreciated that the activated carbon material may be reactivated for subsequent use by any suitable methods, such as by wet air oxidation.

By “fluid communication” as used herein, it is meant that a fluid may flow from one element to another element. It is appreciated there may be numerous components, such as piping, valves, pumps, measuring devices, sensors, controllers, and the like interposed between such elements, which are not necessarily claimed as part of this disclosure and which are simply part of the fluid connection or potential fluid connection.

The present inventor has developed systems and processes for the removal of zinc from a zinc fluid which may substantially minimize waste storage and transportation costs. In the context of an offshore platform, the systems and processes described herein may minimize the amount of water that needs special disposal by retaining zinc salts while allowing most of the water to be discharged to the ocean. In certain embodiments, the amount of water discharged may be >80% of the original volume of zinc fluid 14 in the vessel, and in other embodiments >90% of the original volume. The function and advantages of these and other embodiments of the present invention will be more fully understood from the following examples. These examples are intended to be illustrative in nature and are not considered to be limiting the scope of the invention.

### EXAMPLES

### Example 1

### Salt Handling

Four tanks of produced water were mixed together to give a composite sample which had gravimetric TDS of 2270 mg/L and a zinc concentration of 201 mg/L. Reverse osmosis (RO) was operated with a single tank to concentrate the salts (including zinc) in the composite sample. The flow scheme included travel of the samples from a storage tank through a polyester sock and a polyester sock with carbon to RO. The permeate water was discharged while the concentrate water was sent back to the tank. The RO skid was operated with 8.3 gpm to the membrane; for much of the test, 3 gpm was pushed through the membrane, but as the TDS increased the permeate flow rate was reduced until no more water could be removed.

RO was able to sufficiently treat the water with the permeate water having approximately 20 mg/L TDS and 0 mg/L of zinc according to the field tests performed. After about six hours of operation, the RO had removed over a third of the water with associated ˜3 times concentration of the salts. After 22 hours of total operation, the concentrate stream was reduced from its initial 100 barrels down to 5 barrels of water at 103,000 mg/L TDS. The table below includes a lab analysis of the concentrate and permeate streams at two points in the operation of the RO along with the raw water received.

Analysis of salts in raw water composite and RO results.

| | Raw | 6 hours | 6 hours | 22 hours |
|---|---|---|---|---|
| (mg/L) | Water | Permeate | Concentrate | Concentrate |
| TDS | 2270 | 28 | 9450 | 103000 |
| Barium | 1.25 | | | 24.2 |
| Boron | ND | | | 17.1 |
| Calcium | 134 | | 460 | 4870 |
| Iron | | | | 1070 |
| Magnesium | ND | | | 162 |
| Potassium | 77.4 | | | 649 |
| Silica (SiO2) | ND | | | 35.3 |
| Sodium | 824 | | | 8380 |
| Strontium | 0.964 | | | 40.4 |
| Zinc | 201 | 1.59 | 718 | 7810 |
| Sulfate (as S) | 3.29 | | 4.12 | 67.4 |
| Chloride | 438 | | 1760 | 19300 |
| Bromide | | | | 25200 |
| Fluoride | ND | | | 0.81 |
| Nitrate (as N) | 1.00 | | | ND |
| Ammonia (as N) | 2.32 | | | 83.6 |
| TSS | | | 68 | 192 |
| TOC | | | | 19000 |

The above testing demonstrated the ability to reduce a zinc contaminated water stream to <10% of its initial volume. Where transport of zinc-contaminated water onshore daily was necessary for disposal, a system based on the testing performed in this example when used in an offshore environment could reduce everyday transport to a weekly transport (or possibly even less frequently) while still not discharging zinc to the ocean.

To reiterate, water may be directed from the tank, through the sock filters, carbon and RO with the concentrate going back to the tank and the permeate being discharged, and the process repeated. As water continues to be added to the tank, the RO will retain the zinc while removing most of the water. Eventually, the TDS of the tank will concentrate above a predetermined amount, e.g., >70,000-80,000 mg/L, and the tank will need to be emptied of the high zinc concentrate. Once the tank is emptied, the process may begin again.

### Ion Exchange

### Example 2

As described above, aspects of the present invention utilize a combination of ion exchange (IX), such as strong base anionic (SBA) ion exchange, and reverse osmosis (RO) to provide for extended removal of zinc ions from a zinc fluid, such as zinc-containing produced water, with only a portion of the total flow being waste, e.g., waste to ship onshore. For example, if 500 mg/L Zn is in the water, in certain aspects, the waste stream may be about 2% of total flow in the form of ˜50,000 mg/L zinc chloride).

Zinc ions, while usually cationic, will form anionic complexes (thought to be ZnCl₄²⁻) in salty water. Lab tests have shown that 70 g/L total dissolved solids (TDS) is sufficient to form these complexes while 60 g/L TDS is not enough. In instances of low TDS produced waters, reverse osmosis (RO) can be used before ion exchange (IX) to concentrate the salt up sufficiently to meet that threshold (70 g/L TDS) for effective use of the IX resin, thereby allowing for the IX resin to work efficiently. The effluent from RO could be saved as a regeneration fluid or discharged, and the salty concentrate stream would continue to the IX column.

SBA resins in the Cl⁻ form (e.g., Lanxess' Lewatit Monoplus M800 CL and Dow's Dowex 21K XLT) will retain the anionic zinc complexes while having no retention of any other metal cations. Testing confirmed that no other metals common to produced water are removed. Additionally, due to the complex being a polyatomic, divalent ion, it is removed preferentially over halides (Cl⁻, Br- etc.) that will comprise the remaining anions of the TDS.

Due to the nature of the zinc complexes only forming in salty water, the IX resin—once loaded with zinc—can be simply regenerated with low TDS (<1000 mg/L) water as the regeneration fluid. Flowing low TDS water through the column will cause the zinc complexes to disassociate into zinc cations and chloride anions once again. The SBA resin will no longer retain the zinc since it is now cationic; thus, the zinc will be flushed from the column in solution with the regeneration fluid. The byproduct of the regeneration is relatively pure zinc chloride in water, which may be stored or transported as desired.

Compared to shipping the produced water from a well onshore, zinc-loaded water may be treated on the platform with the bulk of the water being able to be discharged to the ocean. Many offshore platforms without zinc contamination do this, performing the oil-water separation on the platform and discharging to the ocean, as it is much more economical and logistically simpler than collecting the water to ship onshore. Adding an IX column and RO skid after the oil removal steps (e.g. flotation cell followed by GAC columns) will allow wells with zinc contamination to be similarly treated on the platform.

In addition, compared to precipitating with caustic, the processes and systems described herein can be operated with no chemicals, thereby reducing or eliminating the complication of sending hazardous materials to the platform. In a particular embodiment, a caustic material may be added to the zinc byproduct if it is decided that a sludge stream is simpler to deal with. In such a case, the IX/RO system still adds value by having a relatively pure zinc chloride stream. If treating the entire stream, calcium and other metals may be precipitated also, increasing the amount of caustic required and increasing the amount of waste sludge that needs handling. Additionally, there is no need for a settling tank, reducing the weight and footprint over a precipitation system, both of which are at a premium on offshore platforms.

The usage of an SBA resin allows for the superb selectivity of zinc over most other ions in produced water. Additionally, use of an SBA type resin rather than a cationic resin is one reason that RO-treated low TDS water works as the regeneration fluid. Any cationic resin, while still able to remove zinc, would likely remove other metal cations and would require some concentrated acid to regenerate. Moreover, pairing IX with RO helps further in that not only is the regeneration fluid non-hazardous, but it can be generated on site on the platform. Additionally, RO may concentrate the zinc byproduct after regeneration, allowing for a much smaller reject stream than IX alone.

In one aspect, it is appreciated that RO alone would likely be ineffective if the produced water is already very salty. In a low-TDS situation, RO will be able to concentrate the salt (including the zinc) into a waste stream that is smaller than the total flow, allowing for most of the water to be discharged, as described above. However, if the salt is high, the RO alone would be unable to concentrate much more if at all before the osmotic pressure becomes too much of a hindrance. Thus, the IX column is useful to extract only the zinc salts, which can then be concentrated up much higher since there is no other TDS adding to the osmotic pressure.

Since the initial flowback water with all the chemicals is typically more difficult to treat than normal produced water, specialized equipment may be brought to platforms to treat the difficult flowback fluid until it becomes the normal produced water. In wells with zinc contamination, components for IX and RO may be provided on a skid, for example, and the IX and RO skid may be put into operation right after the oil separation in accordance with another aspect of the present invention.

Further, at the current time, most platforms with zinc contamination collect water and send it onshore; therefore, they do not bother with the oil removal steps on the platform. However, aspects of the present invention may allow RO skids and the IX resin to be added to existing vessels used for GAC columns. With RO available, additional fluid can be put through the column, polishing the resin, while adding only slightly to the overall waste stream that needs to be put ashore.

### Zinc Concentration

### Example 3

The below example illustrates a hypothetical case to illustrate the impact of zinc concentration (as a portion of total TDS) on total zinc waste volume. Assuming the following:

2000 bbl/day of 20 g/L TDS fluid.

In case 1, zinc is 2000 mg/L or 10% by vol.

In case 2, zinc is 200 mg/L or 1% by vol.

Assume RO can concentrate the fluid to 80 g/L TDS regardless of its constituents. In both cases, if only using RO, the fluid can be reduced from 2000 bbl/day to 500 bbl/day as the TDS goes from 20 to 80 g/L. To determine if adding ion exchange (IX) would be of any value, the following can be considered. The benefit of using the IX resin in an offshore setting is that the non-zinc salts can be discharged to the ocean retaining only zinc chloride. After regeneration of the resin, the zinc chloride waste fluid can be concentrated again with RO to 80 g/L ZnCl₂, i.e. 38.4 g/L Zn (remainder chloride).

Now, in case 1, the 2000 bbl of fluid has (2000 bbl*159 L/bbl*2 g/L=) 636000 g Zn, at the max concentration mentioned above to provide a final volume of 104 bbl. In case 1, the 2000 bbl of fluid has one tenth of that, or 63600 g Zn, which can be concentrated to a final volume of 10.4 bbl. Since the shipping and disposal costs are per volume, the IX in both of these cases is definitely worthwhile. See the table below.

| | |
|---|---|
| Case 1 | Case 2 |

| | | | | |
|---|---|---|---|---|
| No treatment | 2000 | bbl | 2000 | bbl |
| Just RO | 500 | bbl | 500 | bbl |
| RO + IX | 104 | bbl | 10.4 | bbl |

As seen, the benefits in case 2 are higher than the benefits of case 1 since the addition of IX reduced the volume more, saving more money in shipping/disposal costs. In addition, as the zinc becomes a higher percentage of the TDS, the benefit of RO will be the same (for the same total salts), but the remaining waste after IX will continue to increase, thereby reducing the benefits of IX. In all cases when zinc concentrated is <10% by weight, it is still expected to be worthwhile to have that IX component there. When zinc starts to be more than 10% of the salts, not only are additional steps (which are very expensive due to the limited space offshore) required, but the volume reduction of final waste is going to continue to decrease as the final waste concentration is limited. For example, at 20% by weight zinc, the final waste will be 208 bbl, thus saving only an additional 300 bbl compared to the RO alone's 1500 bbl.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

1-39. (canceled)

40. A process for reducing zinc waste volume comprising:
concentrating a zinc fluid comprising zinc and a total dissolved solids (TDS) concentration of less than 70 g/L to generate a concentrate comprising anionic zinc complexes, metal cations other than zinc, and a TDS concentration of at least about 70 g/L; and
contacting the concentrate with an anionic ion exchange resin to selectively remove the anionic zinc complexes from the metal cations other than zinc via the resin, thereby generating a zinc-reduced effluent.

41. The process of claim 40, wherein the concentrating is done by a process selected from the group consisting of reverse osmosis, evaporation, forward osmosis and nanofiltration.

42. The process of claim 40, wherein the concentrating is done by reverse osmosis, and wherein the concentrating is effective to generate a permeate and the concentrate.

43. The process of claim 42, further comprising regenerating the anionic ion exchange resin with a permeate from reverse osmosis, the permeate having a total dissolved solids concentration of about 1000 mg/L or less.

44. The process of claim 40, wherein the zinc fluid comprises at least one of produced water or flowback water from oil production.

45. The process of claim 40, wherein the resin comprises a strong base anionic ion exchange resin.

46. The process of claim 40, wherein the contacting the concentrate with the anionic ion exchange resin comprises:
introducing a flow of the concentrate to a first column comprising the anionic ion exchange resin and on to a second column comprising the anionic ion exchange resin in flow series with the first column, the second column downstream of the first column; and
upon at least partially loading of the first column with zinc, removing the first column, regenerating the first column, and placing the first column downstream of the second column such that the second column is then first contacted with the concentrate.

47. A process for reducing zinc waste volume comprising:
contacting a zinc fluid with an anionic ion exchange resin to generate a zinc-reduced effluent, the zinc fluid comprising anionic zinc complexes and a total dissolved solids concentration of 70 g/L or more;
providing a regeneration fluid having a total dissolved solids concentration of less than 1000 mg/L; and
regenerating the anionic ion exchange resin with the regeneration fluid.

48. The process of claim 47, wherein the providing is done by subjecting at least a portion of the zinc-reduced effluent to reverse osmosis and utilizing a permeate from reverse osmosis as the regeneration fluid.

49. The process of claim 47, wherein the generating is done by subjecting seawater to reverse osmosis and utilizing a permeate from reverse osmosis as the regeneration fluid.

50. The process of claim 47, wherein the zinc fluid comprises at least one of produced water or flowback water from oil production.

51. The process of claim 47, wherein the resin comprises a strong base anionic ion exchange resin.

52. A process for reducing zinc waste volume comprising:
directing a zinc fluid from a storage vessel to a concentrator to generate a concentrate and a zinc-reduced fluid;
returning the concentrate to the storage vessel; and
repeating the directing and returning one or more times to produce a reduced volume and concentrated zinc product in the storage vessel.

53. The process of claim 52, wherein the concentrator comprises a reverse osmosis unit.

54. The process of claim 52, wherein the zinc fluid comprises produced water.

55. The process of claim 54, further comprising separating an amount of oil from the produced water prior to directing the zinc fluid to the concentrator.

56. The process of claim 54, further comprising separating an amount of organic contaminants from the produced water prior to input of the produced water to the concentrator.

57. The process of claim 52, wherein the zinc fluid comprises a total dissolved solids (TDS) concentration of about 10,000 mg/L or less.

58. The process of claim 52, wherein the directing and returning steps are repeated until the concentrated zinc product in the storage vessel comprises a total dissolved solids concentration of about 70,000 mg/L or more.

59. The process of claim 52, further comprising discharging the zinc-reduced fluid to an ocean.
